(19) United States
(12) Patent Application Publication
(10) Pub. No.: US 2012/0154730 A1
(43) Pub. Date: Jun. 21, 2012

(54) LIQUID CRYSTAL DISPLAY DEVICE

(76) Inventors: Takehisa Sakurai, Osaka-shi (JP); Mitsuhiro Murata, Osaka-shi (JP); Tadashi Ohtake, Osaka-shi (JP); Shoichi Ishihara, Osaka-shi (JP); Shuichi Kozaki, Osaka-shi (JP); Yuhko Hisada, Osaka-shi (JP)

(21) Appl. No.: 13/389,882

(22) PCT Filed: Mar. 8, 2010
(86) PCT No.: PCT/JP2010/053814

§ 371 Date: Feb. 29, 2012

(30) Foreign Application Priority Data
Aug. 24, 2009 (JP) 2009-193030
Jan. 13, 2010 (JP) 2010-005109

(51) Int. Cl. G02F 1/1343

(52) U.S. Cl. 349/141

(57) ABSTRACT

The present invention provides a liquid crystal display device having an improved aperture ratio. The liquid crystal display device of the present invention comprises: a pair of substrates positioned to face each other; and a liquid crystal layer interposed between the substrates, wherein the liquid crystal layer contains a liquid crystal molecule having positive dielectric anisotropy, the liquid crystal molecule is aligned in a direction vertical to surfaces of the substrates when no voltage is applied, one of the substrates comprises a first electrode and a second electrode, the electrodes respectively including comb-tooth portions that are alternately engaged at a certain interval, the first electrode comprises an extension in a layer separated by an insulating film from a layer in which an engagement between the comb-tooth portions of the first electrode and of the second electrode is formed, and the extension of the first electrode is positioned more distant from the liquid crystal layer than the comb-tooth portion of the second electrode is, and is positioned along the comb-tooth portion of the second electrode in an overlapping manner.

### TECHNICAL FIELD

The present invention relates to a liquid crystal display device. More specifically, the present invention relates to a liquid crystal display device in which liquid crystal molecules are initially vertically aligned and are controlled by an electric field (e.g. transverse electric field) generated.

### BACKGROUND ART

Liquid crystal display devices (LCD) have advantageous features, such as thin profile, light weight, and low power consumption, which allow their wide use in various fields. The display performance thereof has been significantly improved for years and now almost beats the display performance of CRT (cathode ray tube).

The alignment of liquid crystals in the cell determines the display mode of a liquid crystal display device. Conventional display modes of liquid crystal display devices include TN (Twisted Nematic) mode, MVA (Multi-domain Vertical Alignment) mode, IPS (In-plane Switching) mode, and OCB (Optically self-Compensated Birefringence) mode.

Among these, the IPS mode is a mode in which liquid crystal molecules rotate in an in-plane direction to rotate effective retardation and thereby transmittance is controlled. A LCD in the IPS mode may provide a wide viewing angle as the retardation of liquid crystals is not so much changed by variation of the viewing angle. A comb-tooth electrode is utilized in a common method of applying the transverse electric field (see Patent Document 1).

In Patent Document 1, a comb-tooth electrode especially has a two-layer structure. When a single common electrode is positioned in a lower layer, a single pixel electrode is positioned in an upper layer. On the other hand, when a single pixel electrode is positioned in the lower layer, a single common electrode is positioned in the upper layer. Moreover, the positional relation (upper/lower) between the pixel electrode and the common electrode is exchanged for each pair. Patent Document 1 discloses the following embodiment with regard to the width of the electrode positioned in the lower layer of the two-layer structure. Namely, when the width of the pixel electrode positioned in a layer on a liquid crystal layer side is “W1” and the width of the common electrode positioned in a layer on a transparent electrode side is “W2”, a relation of W2/2<W1≦W2 is satisfied. Moreover, when the width of the common electrode positioned in the layer on the liquid crystal layer side is “W1′” and the width of the pixel electrode positioned in the layer on the transparent electrode side is “W2′”, a relation of W2′/2<W1′≦W2′ is satisfied.

### [Patent Document 1]

Japanese Kokai Publication No. 2009-37154 (JP-A 2009-37154)

### DISCLOSURE OF INVENTION

### Problems to be Solved by the Invention

Recently, as a display mode different from the IPS mode, there has been proposed a display mode in which nematic liquid crystals having positive dielectric anisotropy are used as a liquid crystal material and are vertically aligned to maintain high-contrast display, and a pair of electrodes having a comb-tooth structure generate a transverse electric field to control the alignment of liquid crystal molecules. In the following, the process to arrive at the present invention is described by exemplifying the above mode. However, the present invention is not limited to the above mode.

FIGS. 14 and 15 are schematic views each illustrating one example (reference example) of a structure of a liquid crystal display device in which a pair of substrates having a comb-tooth structure generate a transverse electric field in a liquid crystal layer including nematic liquid crystals that are initially vertically aligned and have positive dielectric anisotropy. FIG. 14 is a schematic plan view and FIG. 15 is a schematic cross-sectional view.

As illustrated in FIG. 14, a liquid crystal display of a reference example in the above mode has a pair of substrates 150 and 160. Between the substrates 150 and 160, a liquid crystal layer 140 is sealed. The substrates 150 and 160 respectively have transparent substrates 151 and 161 as a main body. The transparent substrate 151 has an insulating film 154 thereon. On the insulating film 154, a pair of comb-shaped electrodes including a pixel electrode 121 and a common electrode 122 are positioned. On the insulating film 154 and the comb-shaped electrodes 121 and 122, vertical-alignment films 152 and 162 are placed. Because of an influence of the vertical alignment films 152 and 162, any of liquid crystal molecules 104 are vertically aligned (homeotropic alignment) when no voltage is applied to the liquid crystal layer 140. Voltage application to the liquid crystal layer 140 is conducted by the comb-shaped electrodes 121 and 122 each formed on one of the substrates 150 and 160. Transmission or blocking of light is determined by polarizers 153 and 163 positioned on the transparent substrates 151 and 161 on the opposite side of the liquid crystal layer.

According to the above mode, when a voltage is applied by the respective comb-shaped electrodes 121 and 122 (e.g. the electric potential of the comb-shaped electrode 121 is set to V and the electric potential of the other comb-shaped electrode 122 is set to 0), the liquid crystal molecules 104 are aligned in a bend alignment in a transverse direction, the director profile forms an arch along the transverse electric field, and the complementary alignment is observed between the adjacent two electrodes 121 and 122. Therefore, even from a direction oblique to the display surface, it is possible to enjoy the display quality similar to the quality enjoyable from the front direction. Accordingly, it is possible to solve a problem that the voltage-transmissivity characteristics (V-T characteristics) may change in accordance with the angle because the optical birefringence is different between the front direction and the oblique direction due to stick-shaped liquid crystal molecules, as in the VA mode.

As illustrated in FIG. 15, the liquid crystal display device of the reference example in the above mode has a pair of comb-shaped electrodes 121 and 122 respectively having comb-tooth portions alternately engaged at certain intervals. One of the pair of substrates is the pixel electrode 121 and is connected to a source wiring 111 via a TFT 117 of which timing is controlled by a gate wiring 112.

Specifically, the TFT 117 has a semiconductor layer 134, a gate electrode 132, a source electrode 131, and a drain electrode 133. The source electrode 131 connected to the source wiring 111 is connected to the drain electrode 133 via the semiconductor layer 134. Application of a gate voltage to the gate electrode 132 connected to the gate wiring 112 electrically connects the source electrode 131 with the drain electrode 133 via the semiconductor layer 134. The drain electrode 133 is running in the row direction along the gate wiring 112 and also running towards the center of a picture element. At the center of the picture element, the drain electrode 133 is connected to a Cs electrode 134 having a wide area. The Cs electrode 135 is connected to the pixel electrode 121 via a contact portion 141 provided in an insulating film formed on the drain electrode 133 and the Cs electrode 135. The pixel electrode 121 has a part parallel with the gate wiring 112, and a comb-tooth portion that is parallel with the source wiring 111 and is protruding from the part parallel with the gate wiring 112.

Above the gate wiring 112 and the source wiring 111, the common electrode 122 is positioned along with these wirings. The gate wiring 112, the source wiring 111, and the common electrode 122 are respectively positioned in different layers each separated by an insulating film. The common electrode 122 has a portion parallel with the gate wiring 112, a portion parallel with the source wiring 111, and a comb-tooth portion that is planarly protruding from the portion parallel with the gate wiring 112 or with the source wiring 111 and is parallel with the source wiring 111.

Moreover, the liquid crystal display device of the reference example in the above mode has a Cs wiring 113 underlying the Cs electrode 135. The Cs electrode 135 and the Cs wiring 113 are respectively positioned in different layers separated by an insulating film. A certain amount of storage capacitance can be generated therebetween, and therefore, the voltage of the pixel electrode 121 can be stably maintained.

However, the present inventors noticed that removal of Cs wirings and Cs electrodes as far as possible is preferable from the standpoint of the aperture ratio in order to enhance the display quality in the liquid crystal display device of the reference example in the above mode.

The present invention has been devised in consideration of such a state of the art and is aimed to provide a liquid crystal display device having an enhanced aperture ratio.

### Means for Solving the Problems

The present inventors have made intensive studies on a means of generating a storage capacitance for assisting in the maintenance of the voltage in an electrode for driving liquid crystals without forming Cs wirings and Cs electrodes. The present inventors then focused on the configuration of two electrodes to which different voltages for controlling the alignment of liquid crystals are applied. The present inventors found out that, in the case of the reference example, generation of a storage capacitance between a pixel electrode and a common electrode, instead of generation of a storage capacitance for a pixel electrode using a Cs electrode connected to a drain electrode, allows reduction of a part of or all of drain electrodes, Cs electrodes, and Cs wirings which are extended to the central part of a picture element.

Specifically, an extension from a common electrode is positioned along a comb-tooth portion of a pixel electrode in an overlapping manner by interposing an insulating film therebetween and/or an extension from a pixel electrode is positioned along a comb-tooth portion of a common electrode in an overlapping manner by interposing an insulating film therebetween. This allows generation of an enough storage capacitance for the pixel electrode. Since formation of an extension of a drain electrode, a Cs electrode and a Cs wiring, in addition to a region where the pixel electrode and the common electrode are positioned, is not needed, the aperture ratio can be enhanced. Based on the above findings, the present inventors solved the above problem and arrived at the present invention.

Namely, the present invention is a liquid crystal display device comprising: a pair of substrates positioned to face each other; and a liquid crystal layer interposed between the substrates, wherein the liquid crystal layer contains a liquid crystal molecule having positive dielectric anisotropy, the liquid crystal molecule is aligned in a direction vertical to surfaces of the substrates when no voltage is applied, one of the substrates comprises a first electrode and a second electrode, the electrodes respectively including comb-tooth portions that are alternately engaged at a certain interval, the first electrode comprises an extension in a layer separated by an insulating film from a layer in which an engagement between the comb-tooth portions of the first electrode and of the second electrode is formed, and the extension of the first electrode is positioned more distant from the liquid crystal layer than the comb-tooth portion of the second electrode is, and is positioned along the comb-tooth portion of the second electrode in an overlapping manner.

Hereinafter, the present invention is described in detail.

The liquid crystal display device of the present invention comprises a pair of substrates positioned to face each other, and a liquid crystal layer interposed between the substrates. The liquid crystal layer is filled with liquid crystal molecules of which alignment is controlled by certain voltage application. Wirings, electrodes, semiconductor elements and the like provided on the one of or both of the substrates enable voltage application to the liquid crystal layer so that the alignment of liquid crystal molecules is controlled.

The liquid crystal layer contains liquid crystal molecules having positive dielectric anisotropy. Therefore, voltage application to the liquid crystal layer aligns the liquid crystal molecules along the direction of the electric field. As a result, the liquid crystal molecules are aligned, for example, in an arch shape.

The liquid crystal molecules are aligned in the direction vertical to the surface of the first substrate when no voltage is applied. The initial alignment of the liquid crystal molecules set in this manner efficiently shields light during black display. An exemplary method for vertically aligning the liquid crystal molecules when no voltage is applied includes providing vertical alignment films on the surface contacting with the liquid crystal layer of one of or both of the substrates contacting the liquid crystal layer. In the present description, the word “vertical” not only refers to “strictly vertical” but also refers to “substantially vertical”. The range of “vertical” here is 90±2°.

One of the substrates has a first electrode and a second electrode which have comb-tooth portions alternately engaged at certain intervals. The electric field generated by the potential difference given between the electrodes having such comb-tooth portions is, for example, an arch-shaped transverse electric field. The liquid crystal molecules show alignment corresponding to the direction of such an electric field. Therefore, the display quality is stable regardless of the eye direction relative to the substrate surface such as the front direction and an oblique direction. As a result, fine viewing angle properties are achieved.

The first substrate has an extension in a layer separated by an insulating film from the layer in which an engagement with the comb-tooth portion of the second electrode is formed. The extension of the first electrode is positioned more distant from the liquid crystal layer than the comb-tooth portion of the second electrode is, and is positioned along the comb-tooth portion of the second electrode in an overlapping manner. Namely, the first electrode has a structure including at least two layers by interposing an insulating film therebetween. Each parts of the first electrode in different layers are mutually connected via a contact hole, for example. The comb-tooth portions of the first electrode and of the second electrode are used for controlling the alignment of liquid crystal molecules in the liquid crystal layer. Therefore, when the extension of the first electrode is positioned more distant from the liquid crystal layer than the comb-tooth portions of the first electrode and of the second electrode are, a more uniform electric field is formed in the liquid crystal layer.

The configuration of the liquid crystal display device of the present invention is not especially limited as long as it essentially includes such components. The liquid crystal display device may or may not include other components.

The extension of the first electrode preferably has a width narrower than the width of the comb-tooth portion of the second electrode. The width of the comb-tooth portion refers to the dimension of the comb-tooth portion in the short-axis direction. The present inventors clarified that when the width of the electrode on the side more distant from the liquid crystal layer is wider than the width of the electrode on the side closer to the liquid crystal layer, larger transmissivity is achieved compared to the case where the width of the electrode on the side closer to the liquid crystal layer is wider than the width of the electrode on the side more distant from the liquid crystal layer.

The second electrode preferably has an extension in a layer separated by the insulating film from the layer in which the engagement with the comb-tooth portion of the first electrode is formed, and the extension of the second electrode is preferably positioned more distant from the liquid crystal layer than the comb-tooth portion of the first electrode is, and is positioned along the comb-tooth portion of the first electrode in an overlapping manner. When the second electrode, in addition to the first electrode, also has the above relation, the storage capacitance may be made greater. In this case, the extensions of the first electrode and of the second electrode may be alternately engaged at certain intervals or may not be engaged to each other. Moreover, the extension of the second electrode preferably has a width narrower than the width of the comb-tooth portion of the first electrode.

Examples of a combination of the first electrode and the second electrode include a combination of a pixel electrode as the first electrode and a common electrode as the second electrode, and a combination of a common electrode as the first electrode and a pixel electrode as the second electrode.

### Effect of the Invention

According to the present invention, it is possible to increase the aperture ratio in a liquid crystal display device which generates an electric field (e.g. transverse electric field) in a liquid crystal layer by using a pair of electrodes each having a comb-tooth structure, the liquid crystal layer containing nematic liquid crystals that are initially vertically aligned and have positive dielectric anisotropy.

### BRIEF DESCRIPTION OF DRAWINGS

FIG. 1 is a schematic plan view illustrating a picture element of a TFT substrate in a liquid crystal display device according to Embodiment 1.

FIG. 2 is a schematic cross-sectional view of the liquid crystal display device according to Embodiment 1 and shows the alignment of liquid crystal molecules when no voltage is applied in a liquid crystal layer.

FIG. 3 is a schematic cross-sectional view of the liquid crystal display device according to Embodiment 1 and shows the alignment of liquid crystal molecules when a voltage is applied in a liquid crystal layer.

FIG. 4 is a schematic cross-sectional view illustrating the configuration of electrodes in the liquid crystal display device of Embodiment 1 in detail.

FIG. 5 is a graph showing the change in transmissivity according to variation of the ratio between W1 and W2.

FIG. 6 is a graph showing the change in storage capacitance according to variation of the ratio between W1 and W2.

FIG. 7 is a schematic plan view illustrating a manufacturing stage of electrodes and wirings on a TFT substrate of the liquid crystal display device according to Embodiment 1.

FIG. 8 is a schematic plan view illustrating a manufacturing stage of electrodes and wirings on the TFT substrate of the liquid crystal display device according to Embodiment 1.

FIG. 9 is a schematic plan view illustrating a manufacturing stage of electrodes and wirings on the TFT substrate of the liquid crystal display device according to Embodiment 1.

FIG. 10 is a schematic plan view illustrating a manufacturing stage of electrodes and wirings on the TFT substrate of the liquid crystal display device according to Embodiment 1.

FIG. 11 is a schematic plan view illustrating Modified Example 1 of the liquid crystal display device according to Embodiment 1.

FIG. 12 is a schematic plan view illustrating Modified Example 2 of the liquid crystal display device according to Embodiment 1.

FIG. 13 is a schematic plan view illustrating Modified Example 3 of the liquid crystal display device according to Embodiment 1.

FIG. 14 is a schematic plan view of a liquid crystal display device of a reference example.

FIG. 15 is a schematic cross-sectional view of the liquid crystal display device of the reference example.

FIG. 16 is a schematic cross-sectional view illustrating a configuration of a liquid crystal display device according to Embodiment 2.

### MODES FOR CARRYING OUT THE INVENTION

The present invention will be mentioned in more detail referring to the drawings in the following embodiments, but is not limited to these embodiments.

### Embodiment 1

A liquid crystal display device of Embodiment 1 is of a type in which a pair of electrodes formed on the same substrate generates an arch-shaped transverse electric field in a liquid crystal layer to control the alignment of liquid crystal molecules, which are initially vertically aligned, so as to control the image display.

The liquid crystal display device of Embodiment 1 has a liquid crystal display panel including a pair of substrates placed to face each other and a liquid crystal layer interposed between the substrates. More specifically, the liquid crystal display device of Embodiment 1 has a TFT substrate, a liquid crystal layer, and a counter substrate positioned in this order from the back side toward the screen side. The liquid crystal layer contains nematic liquid crystals having positive dielectric anisotropy (Δε>0). Moreover, the liquid crystal display device of Embodiment 1 has a back light unit on the back side. Light emitted from the back light unit penetrates the TFT substrate, the liquid crystal layer, and the counter substrate in this order.

In the liquid crystal display device of Embodiment 1, a plurality of picture elements (sub pixels) formed in a matrix constitute a display region. Driving of each picture element can be individually controlled. A plurality of the picture elements (e.g. three picture elements of red, green, and blue) constitute one pixel. It is to be noted that a picture element here refers to a region surrounded by adjacent gate wirings and adjacent source wirings.

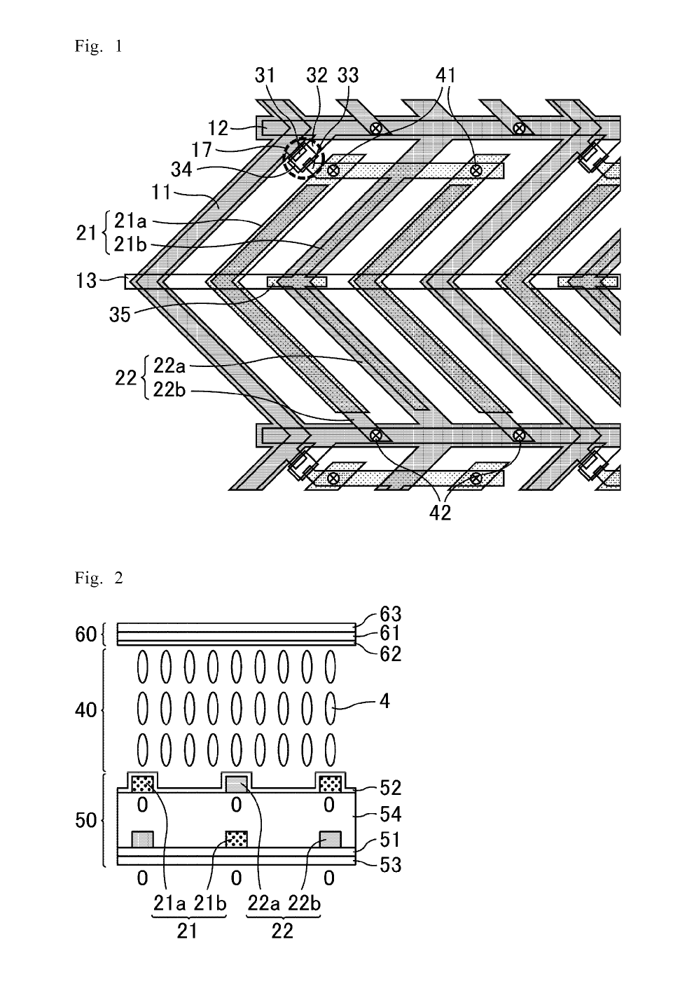

FIG. 1 is a schematic plan view illustrating a picture element of a TFT substrate in a liquid crystal display device according to Embodiment 1. As illustrated in FIG. 1, the TFT substrate is an active matrix substrate comprising a plurality of source wirings 11 arranged in multiple columns for transmitting image signals, a plurality of gate wirings 12 arranged in multiple rows for transmitting scanning signals, and a plurality of thin film transistors (TFT) 17 each serving as a switching element provided in each picture element. The TFT 17 is provided around the intersection of the source wiring 11 and the gate wiring 12. Each TFT has a source electrode 31 connected to the source wiring 11, a gate electrode 32 connected to the gate wiring 12, and a drain electrode 33 connected to the source electrode 31 via a semiconductor layer 34. Moreover, the TFT substrate has a pair of comb-shaped electrodes (first electrode and second electrode) including a pixel electrode 21 and a common electrode 22 for applying a certain voltage to the liquid crystal layer, in each picture element.

The drain electrode 33 is running along the gate wirings 12 in the row direction and also running towards the center of the picture element. At the center of the picture element, the drain electrode 33 is connected to a Cs electrode 35 having a wide area. The drain electrode 33 is connected to a pixel electrode 21 via a contact portion 41 provided in an insulating film positioned over the drain electrode 33 and the Cs electrode 35.

The TFT substrate has a Cs wiring 13 that is running in parallel with the gate wirings 12 and is positioned along the Cs electrode 35 in an overlapping manner. The Cs electrode 35 and the Cs wiring 13 are in different layers by interposing an insulating film therebetween.

Each source wiring 11 is connected to a source driver. The source wiring 11 applies source voltage supplied from the source driver to the pixel electrode 21 via the TFT 17. The source voltage is to be an image signal. Each gate wiring 12 is connected to a gate driver. The gate wiring 12 applies a gate voltage supplied from the gate driver at predetermined timings in a pulsed manner to the TFT 14. The gate voltage is to be a scanning signal. A common voltage maintained at a constant voltage is applied to the common electrode 22.

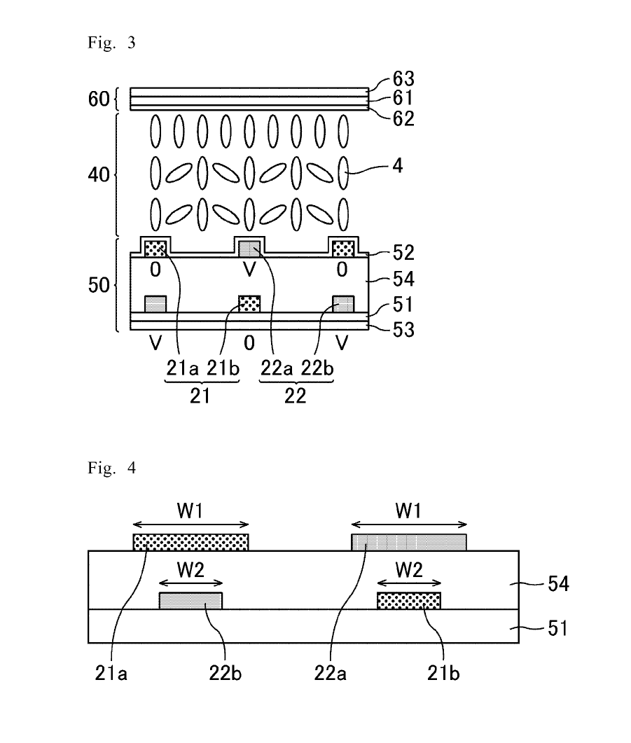

FIGS. 2 and 3 are schematic cross-sectional views of the liquid crystal display device according to Embodiment 1. FIG. 2 shows the alignment of liquid crystal molecules when no voltage is applied in a liquid crystal layer and FIG. 3 shows the alignment of liquid crystal molecules when a voltage is applied in a liquid crystal layer. As illustrated in FIGS. 2 and 3, the liquid crystal display device of Embodiment 1 has a liquid crystal display panel including a pair of substrates including a TFT substrate 50 and a counter substrate 60 and a liquid crystal layer 40 between the TFT substrate 50 and the counter substrate 60.

The TFT substrate 50 has a light-transmissive transparent substrate 51 made of glass, a resin, or the like, as a main body. On the surface of the transparent substrate 51 on the liquid crystal layer 40 side, each of two different layers separated by an insulating film 54 has a structure in which the pixel electrodes 21 and the common electrodes 22 are alternately placed at certain intervals. On the surface of the transparent substrate on the opposite side, a first polarizer 53 is provided.

A combination of the pixel electrodes 21 and the common electrodes 22 in the layer closer to the liquid crystal layer 40 is a combination of comb-tooth portions 21a of the pixel electrode and comb-tooth portions 22a of the common electrode. These comb-tooth portions are alternately placed at certain intervals. An electric field generated between the comb-tooth portions 21a of the pixel electrode and the comb-tooth portions 22a of the common electrode controls the alignment of liquid crystal molecules 4 in the liquid crystal layer 40.

In the TFT substrate 50, a vertical alignment film 52 is formed on the surface contacting the liquid crystal layer 40 of the TFT substrate 50. The vertical alignment film 52 allows the liquid crystal molecules 4 to be initially vertically aligned to the surface of the TFT substrate 50. Materials of the vertical alignment film 52 may be resins such as polyimide.

As illustrated in FIG. 2, the liquid crystal molecules 4 in the liquid crystal layer 40 are aligned in homeotropic alignment, namely, vertically aligned to the surface of the TFT substrate 50, when no voltage is applied (the potential of each electrode is 0). More specifically, the longitudinal axis of each of the stick-shaped liquid crystal molecules 4 is vertical to the substrate surface.

As illustrated in FIG. 3, when the potential of the pixel electrode 21 is set to V and the potential of the counter electrode 22 is set to 0, an electric field is generated between the pixel electrode 21 and the common electrode 22. Then, the alignment of the liquid crystal molecules 4 is changed along with the arch-shaped transverse electric field generated between these electrodes. The liquid crystal molecules 4 influenced by the electric field as above are symmetrically aligned in a bend alignment with respect to an intermediate region between the pixel electrode 21 and the counter electrode 22. Here, as seen in FIG. 3, since the liquid crystal molecules 4 positioned right over the pixel electrode 21 and the common electrode 22 are less likely to be influenced by the change of the electric field, their vertical alignment is maintained. In addition, also with regard to the liquid crystal molecules 4 positioned in the intermediate region between the electrodes 21 and 22, which is the most distant region from the electrodes 21 and 22, the vertical alignment thereof is maintained.

Now, a detailed description is given on a combination of the pixel electrode 21 and the common electrode 22 on the farther side of the liquid crystal layer. This combination is a combination of an extension 21b of the pixel electrode and an extension 22b of the common electrode. The extensions 21b and 22b are alternately positioned at certain intervals. The comb-tooth portion 21a of the pixel electrode and the extension 21b of the pixel electrode are connected to each other via a contact hole formed in the insulating film. The comb-tooth portion 22a of the common electrode and the extension 22b of the common electrode 21 are connected to each other via a contact hole formed in the insulating film 54.

Therefore, the comb-tooth portion 21a of the pixel electrode and the extension 21b of the pixel electrode are at the same potential (V) and the comb-tooth portion 22a of the common electrode and the extension 22b of the common electrode are at the same potential (0).

The extension 22b of the common electrode is positioned along the comb-tooth portion 21a of the pixel electrode in an overlapping manner. The comb-tooth portion 21a of the pixel electrode and the extension 22b of the common electrode are positioned in different layers separated by the insulating film 54 interposed therebetween and are at different potentials. Accordingly, a certain amount of electrostatic capacitance is generated between the comb-tooth portion 21a of the pixel electrode and the extension 22b of the common electrode.

The extension 21b of the pixel electrode is positioned along the comb-tooth portion 22a of the common electrode in an overlapping manner. The comb-tooth portion 22a of the common electrode and the extension 21b of the pixel electrode are positioned in different layers separated by the insulating film 54 interposed therebetween and are at different potentials. Accordingly, a certain amount of electrostatic capacitance is generated between the comb-tooth portion 22a of the pixel electrode and the extension 21b of the common electrode.

These electrostatic capacitances stabilize the potential of the comb-tooth portion 21a of the pixel electrode.

FIG. 1 shows an extension of the drain electrode 33, the Cs wiring 13, and the Cs electrode 35. According to Embodiment 1, it is possible to remove a part of or all of the extension of the drain electrode 33, the Cs wiring 13, and the Cs electrode 35 for generating a storage capacitance according to need. This improves the aperture ratio.

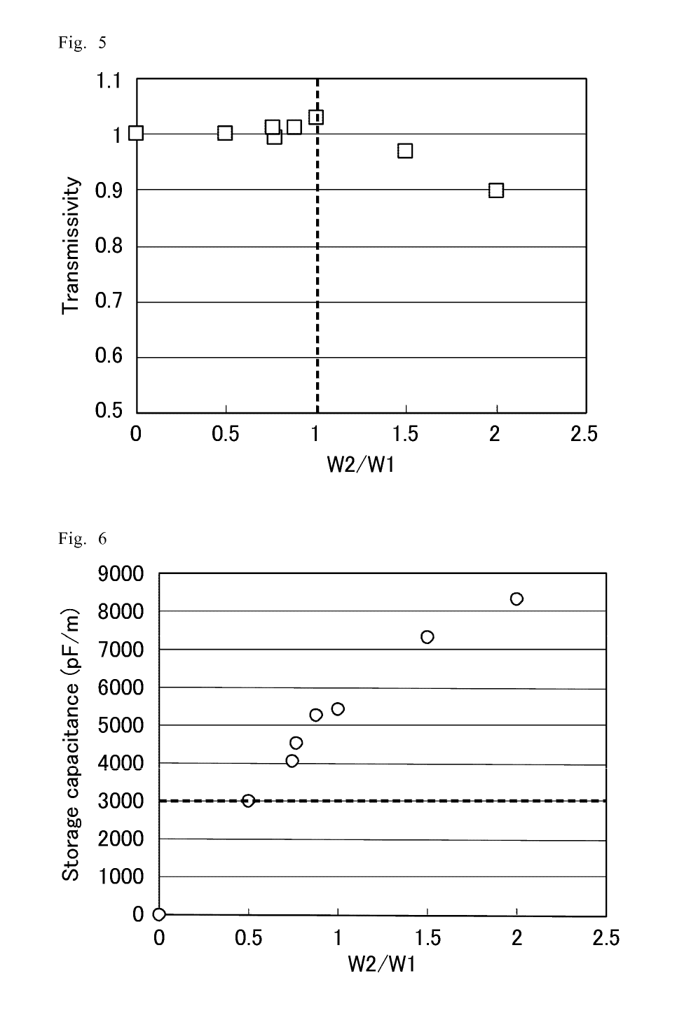

FIG. 4 is a schematic cross-sectional view illustrating the configuration of electrodes in the liquid crystal display device of Embodiment 1. As illustrated in FIG. 4, the comb-tooth portion 21a of the pixel electrode is wider than the extension 22b of the common electrode. Further, the comb-tooth portion 22a of the common electrode is wider than the extension 21b of the pixel electrode. Namely, the electrode on the side closer to the liquid crystal layer 40 is wider than the electrode on the side farther from the liquid crystal layer 40. As illustrated in FIG. 4, when the width of the electrode on the side closer to the liquid crystal layer 40 is W1 and the width of the electrode on the side farther from the liquid crystal layer 40 is W2, a relation of W1>W2 is satisfied.

In the following, a description is given on the reason why the relation of W1>W2 is preferable. FIG. 5 is a graph showing the change in transmissivity according to variation of the ratio between W1 and W2. It is to be noted that the numerical values in the graph are calculated under the condition of L/S=⅜ in which L represents the width of the comb-tooth portion 21a of the pixel electrode and of the comb-tooth portion 22a of the common electrode, and S represents the interval between the comb-tooth portion 21a of the pixel electrode and the comb-tooth portion 22a of the common electrode. The transmissivity was calculated by using a LCD master (SHINTECH. Inc.).

As illustrated in FIG. 5, when W2/W1 is not smaller than 1, namely, when a relation of W1≦W2 is satisfied, the transmissivity is lowered along with the difference between W1 and W2 becomes larger. On the other hand, when W2/W1 is smaller than 1, namely, when the relation of W1>W2 is satisfied, the difference between W1 and W2 has no influence on the transmissivity. From these results, W1>W2 is preferable from the standpoint of transmissivity.

FIG. 6 is a graph showing the change in storage capacitance according to variation of the ratio between W1 and W2. As illustrated in FIG. 6, when the value of W2 becomes larger and larger than the value of W1, storage capacitance (pF/m) tends to increase along with that increase. A certain amount or more of the storage capacitance is needed to reduce the area of the Cs wiring and to enhance the aperture ratio. In the present case, when the storage capacitance of 3000 (pF/m) or more is secured, lowering of the aperture ratio is significantly reduced. Therefore, W2/W1 preferably exceeds 0.5, namely, the value of W2 is preferably larger than the half of the value of W1, from the standpoint of securement of the storage capacitance.

Consequently, W1 and W2 preferably satisfy a relation of W1/2≦W2<W1.

The counter substrate 60 has a light-transmissive transparent substrate 61 made of glass, a resin, or the like, as a main body, and has a second polarizer 63 on the surface on the opposite side of the liquid crystal layer 40 side. The transmission axes of the first polarizer 53 and of the second polarizer 63 satisfy a crossed-Nicol relation. Moreover, the transmission axes of the first polarizer 53 and of the second polarizer 63 respectively form angles of substantially 45° relative to the comb-tooth portion 21a of the pixel electrode and to the comb-tooth portion 22a of the common electrode.

In Embodiment 1, it is possible to conduct display in color by providing color filters on the TFT substrate 50 or the counter substrate 60. The color filters are constituted, for example, by three colors including red, green, and blue. A color filter of a single color is made to correspond with a single picture element so that each color can be separately driven. A desired color can be obtained by a unit of a pixel comprising a red picture element, a green picture element, and a blue picture element. The colors of the color filters are not particularly limited to these colors, and four or more color filters may constitute a unit of a pixel. Moreover, a black matrix (BM) may be provided between the color filters. This prevents mixing of colors or light leakage.

A vertical alignment film 62 is formed on the counter substrate 60 on the surface contacting the liquid crystal layer 40. The vertical alignment film 62 makes the liquid crystal molecules 4 initially vertically aligned to the counter substrate 60 surface.

The TFT substrate 50 and the counter substrate 60 are bonded to each other by a sealing agent applied along the periphery of the display region via a columnar spacer such as resins.

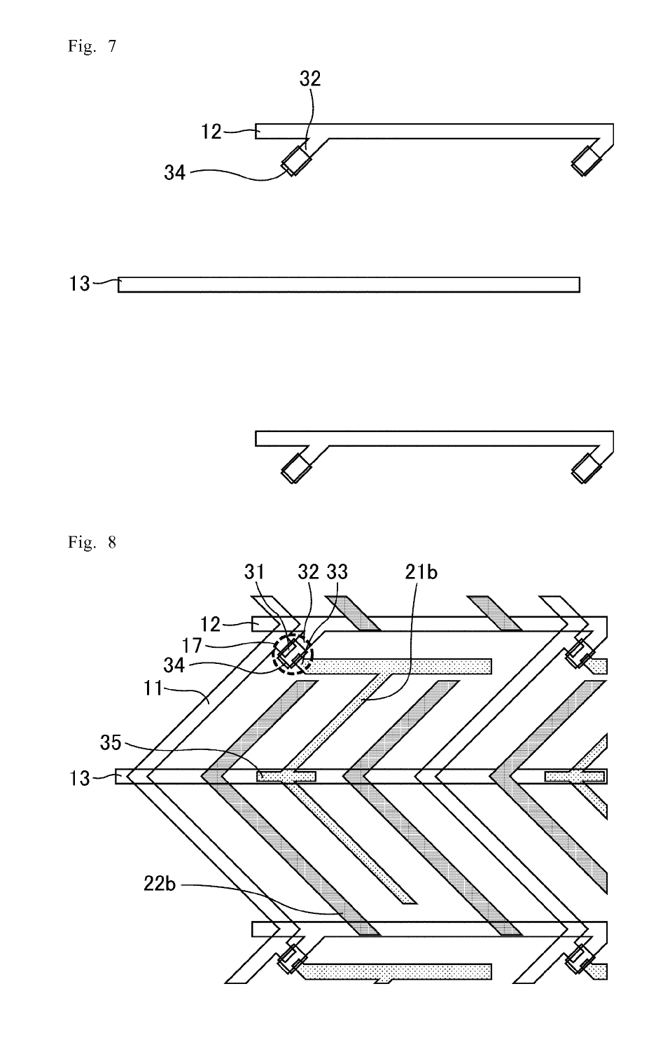

Hereinafter, the process of forming electrodes and wirings on the TFT substrate of the liquid crystal display device of Embodiment 1 is sequentially described with reference to schematic plan views. FIGS. 7 to 10 are schematic plan views each illustrating a manufacturing stage of electrodes and wirings on the TFT substrate of the liquid crystal display device according to Embodiment 1.

First, as illustrated in FIG. 7, a plurality of wirings are provided which are linearly running in the row direction and are in parallel with one another, as the gate wirings 12. As the Cs wiring 13 for generating a storage capacitance, a wiring is provided at a position between each of the adjacent gate wirings 12. Each of the Cs wiring 13 is linearly running in the row direction and is in parallel with the gate wirings 12. Wirings are extended from the gate wirings 12, as wirings to be the gate electrodes 32 of the TFT. Moreover, after formation of a gate insulating film over the entire range of the gate wirings 12 and the Cs wirings 13, semiconductor layers 34 are formed at positions overlapping the gate electrodes 32 via the gate insulating film.

Next, as illustrated in FIG. 8, a plurality of wirings are provided which are running in the column direction in a shape of V rotated to the right by 45° in each picture element and in parallel with one another, as the source wirings 11. Each source wiring 11 has a zigzag shape in the whole display region. Each source wiring 11 is provided to cross the gate wirings 12 and the Cs wirings 13 via an insulating film.

Along with formation of source electrodes 31 and drain electrodes 33 of the TFT, each drain electrode 33 is extended along the gate wirings 12 towards the center of the picture element. Moreover, at the position overlapping the Cs wiring 13 via the insulating film, the drain electrode 33 is further extended along the Cs wiring 13 to form an linear section (hereinafter, also referred to as a Cs electrode 35). In this manner, a certain amount of the storage capacitance is generated between the Cs wiring 13 and the Cs electrode 35 to keep the potential of the pixel electrode stabilized. In addition, the drain electrode 33 is extended from the CS electrode 35 towards the vicinity of the adjacent gate wiring 11. In the later process, the drain electrode 33 is connected to the pixel electrode. The part extended from the drain electrode 33 to the center of the picture element and the part extended from the Cs electrode 35 to the vicinity of the adjacent gate wiring 12 constitute the extension 21b of the pixel electrode.

Electrodes parallel with the source wirings 11 and with the extensions 21b of the pixel electrode are formed between the source wirings 11 and the extensions 12b. Each of the electrodes parallel with the source wirings 11 and with the extensions 12b are later connected to the common electrode and constitutes the extension of the common electrode 22b.

As illustrated in FIG. 8, the extensions 21b of the pixel electrode and the extensions 22b of the common electrode are formed in the same layer and alternately positioned at certain intervals.

In Embodiment 1, the extension 21b of the pixel electrode is a part generating a storage capacitance with the comb-tooth portion 22a of the common electrode which will be formed later. The extension 22b of the common electrode is a part generating a storage capacitance with the comb-tooth portion 21a of the pixel electrode which will be formed later. The length of the extensions 21b of the pixel electrode and of the extensions 22b of the common electrode may be appropriately adjusted in accordance with the required storage capacitance.

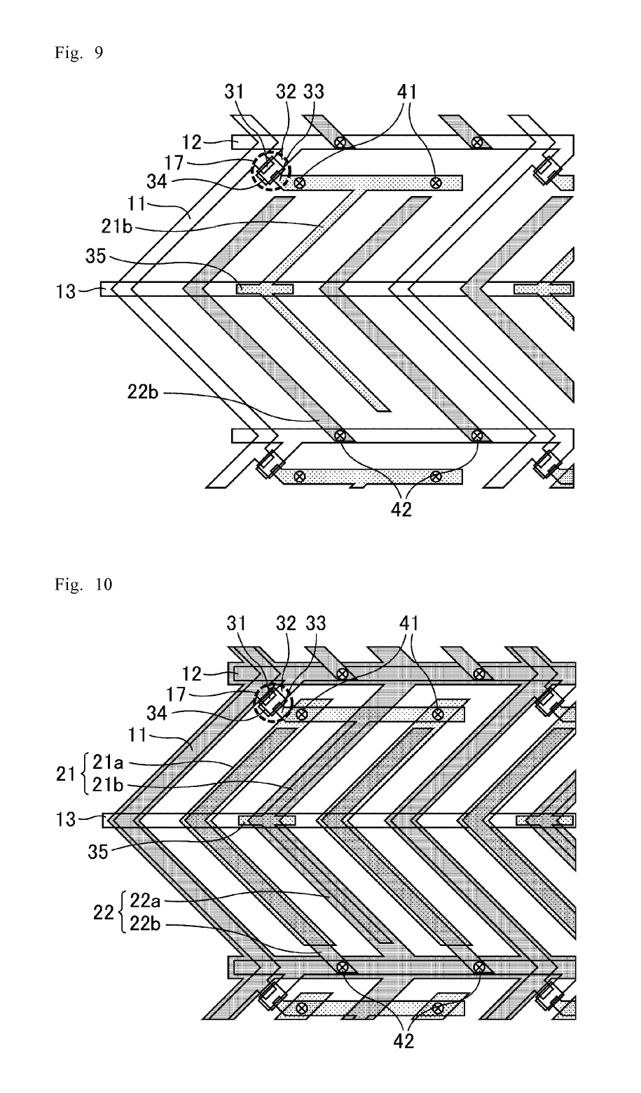

Next, an insulating film is formed over the entire range of the extensions 21b of the pixel electrode and the extensions 22b of the common electrode. As illustrated in FIG. 9, two contact portions (first contact portions) 41 are provided at the end portions of each extension 21b of the pixel electrode. These two contact portions 41 are for connecting the drain electrode 33 with the pixel electrode 21 and are provided in the insulating film formed between the drain electrode 33 and the pixel electrode 21. This arrangement connects the TFT 17 with the pixel electrode via the drain electrode 33 and each contact portion 41. Then, the source wiring 11 is allowed to supply an image signal to the pixel electrode 21 at a predetermined timing via the TFT 17 that has been in the ON state for a predetermined time period due to a scanning signal inputted thereto.

Moreover, as illustrated in FIG. 9, two contact portions (second contact portions) 42 are provided at the end portions of each extension 22b of the common electrode. Each of these two contact portions 42 is for connecting the extension 22 of the common electrode with the common electrode formed later and is provided in the insulating film formed between the extension 22 of the common electrode and the common electrode formed later.

The material of the insulating film may be, for example, an inorganic material such as silicon nitride and silicon oxide or an organic material such as an acrylic resin. The thickness of the insulating film is preferably 0.1 to 3 μm from the standpoint of generation of a storage capacitance.

Next, the comb-tooth portions 21a of the pixel electrode and the comb-tooth portions 22a of the common electrode are formed on the insulating film as illustrated in FIG. 10. Two pieces of the comb-tooth portions 21a are provided in the pixel electrode, which are running from the position overlapping with the first contact portion 41 towards the adjacent gate wiring 12.

The common electrode 22 is provided in a layer separated by an insulating film from the layer where the source wiring 1 and the gate wiring 12 are provided to overlap with the source wiring 11 and the gate wiring 12. This configuration makes the common electrode 22 have a matrix shape corresponding to the combined shape of the source wiring 11 and the gate wiring 12 in the whole display region.

Moreover, the comb-tooth portions 22a of the common electrode are each provided by planarly extending a part of the matrix shape. The comb-tooth portions 22a of the common electrode are each electrically connected to the extension 22b of the common electrode via the second contact portion 42.

The comb-tooth portions 21a of the pixel electrode and the comb-tooth portions 22a of the common electrode are each in a shape of V rotated to the right by 45° in each picture element and in parallel with one another. The comb-tooth portions 21a of the pixel electrode and the comb-tooth portions 22a of the common electrode are alternately engaged at certain intervals. Moreover, the comb-tooth portions 21a of the pixel electrode and the comb-tooth portions 22a of the common electrode are also in parallel with the source wiring 11.

The width W1 of the comb-tooth portion 21a of the pixel electrode and of the comb-tooth portion 22a of the common electrode is preferably 1 to 6 μm and more preferably 2.5 to 4.0 μm.

The width W2 of the extension 21b of the pixel electrode and of the extension 22b of the common electrode is narrower than the width of the comb-tooth portion 21a of the pixel electrode and of the comb-tooth portion 22a of the common electrode. The width W2 is preferably 1.0 to 5.5 μm, and more preferably 1.5 to 3.5 μm.

This sufficiently satisfies the relation of W1/2≦W2<W1.

The interval between the comb-tooth portion 21a of the pixel electrode and the comb-tooth portion 22a of the common electrode is preferably 2.5 to 20.0 μm and is more preferably 4.0 to 12.0 μm.

Examples of the material of the pixel electrode 21 and of the common electrode 22 include metal oxides such as ITO (Indium Tin oxide) and IZO (Indium Zinc Oxide), and metals such as aluminum and chromium. From the standpoint of enhancement of the transmissibity, a light-transmissive metal oxide is preferable.

Examples of the material of the gate wiring 12, the source wiring 11, the Cs wiring 13, the Cs electrode 35, and the following TFT-17 components of the gate electrode 32, the source electrode 31, and the drain electrode 33 include metals such as tantalum, tungsten, titanium, aluminum, chromium, and copper.

The comb-tooth portion 21a of the pixel electrode and the comb-tooth portion 22a of the common electrode, which are to be paired, are in the same layer. Therefore, the production process thereof may be simplified by using the same material.

In this manner, a TFT substrate having a basic configuration as illustrated in FIG. 1 is obtained. Here, the configurations illustrated in FIGS. 1 and 10 are the same.

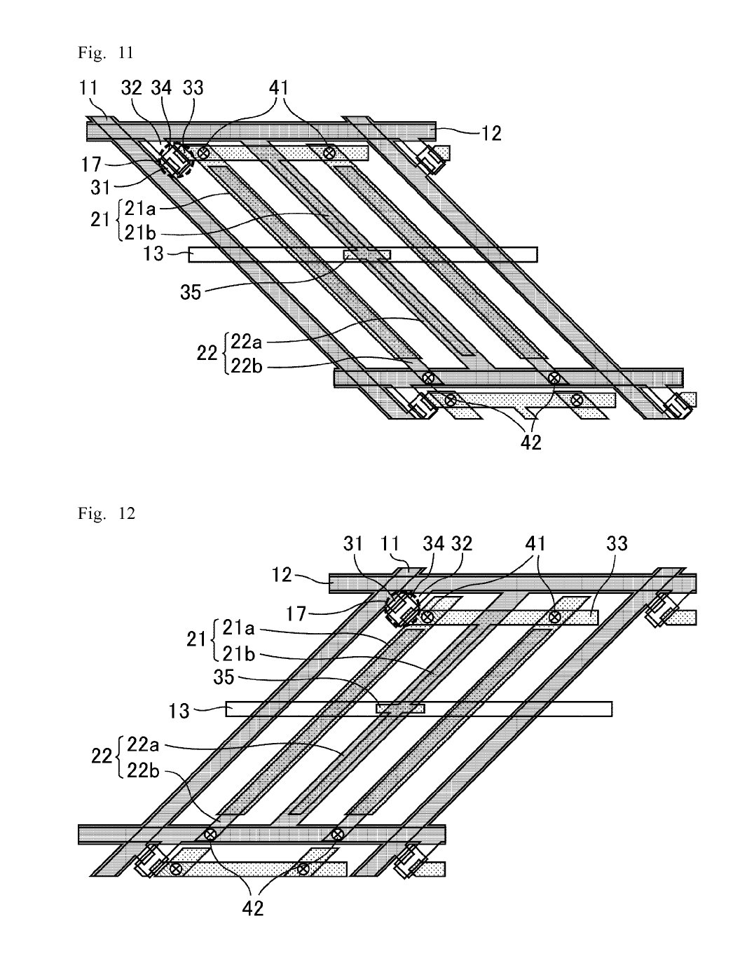

In FIG. 1, the comb-tooth portions 21a of the pixel electrode and the comb-tooth portions 22a of the common electrode each have a symmetric shape with respect to the Cs wiring 13, namely, in a shape of V rotated to the right by 45°. Moreover, the comb-tooth portions 21a of the pixel electrode and the comb-tooth portions 22a of the common electrode may have a linear shape extending in a direction oblique to the running direction of the gate wiring 12, as illustrated in FIGS. 11 and 12. In such a case, the source wiring 11 needs to run in a direction oblique to the running direction of the gate wiring 12 in accordance with the shape of the comb-tooth portions 21a of the pixel electrode and of the comb-tooth portions 22a of the common electrode. Also, the extensions 21b of the pixel electrode and the extensions 22b of the common electrode need to run in a direction oblique to the running direction of the gate wiring 12 in accordance with the shape of the comb-tooth portions 21a of the pixel electrode and of the comb-tooth portions 22a of the common electrode in this case.

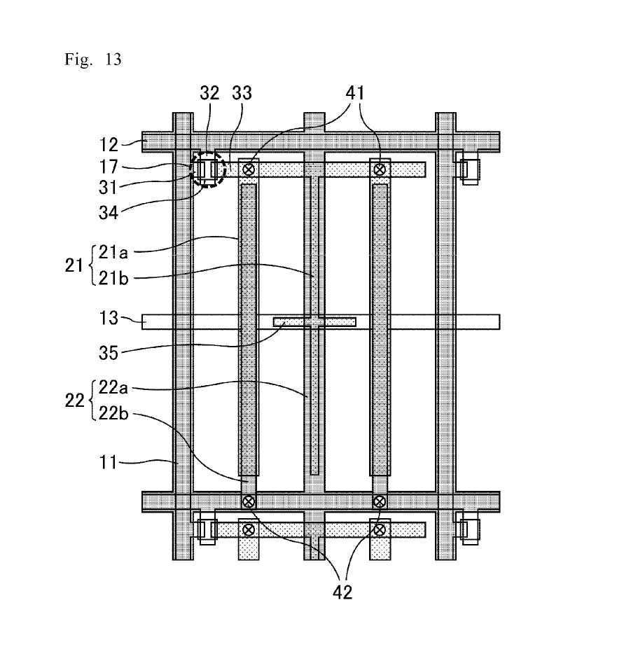

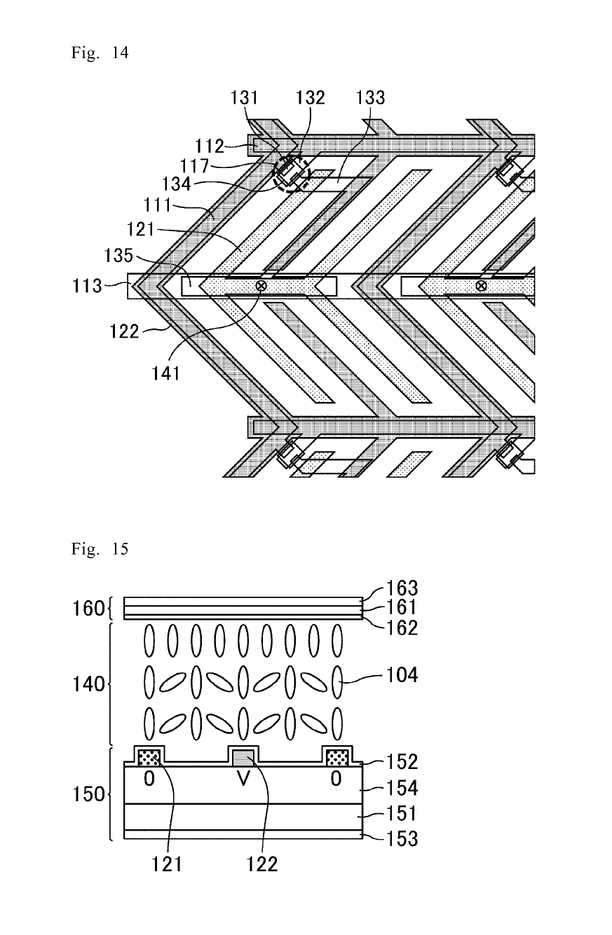

The comb-tooth portions 21a of the pixel electrode and the comb-tooth portions 22a of the common electrode in Embodiment 1 may have a linear shape extending in a direction orthogonal to the running direction of the gate wiring 12 as illustrated in FIG. 13. In such a case, the source wiring 11 also needs to run in a direction orthogonal to the running direction of the gate wiring 12 in accordance with the shape of the comb-tooth portions 21a of the pixel electrode and the comb-tooth portions 22a of the common electrode.

As mentioned above, FIG. 11 is a schematic plan view illustrating Modified Example 1 of the liquid crystal display device of Embodiment 1. FIG. 12 is a schematic plan view illustrating Modified Example 2 of the liquid crystal display device of Embodiment 1. FIG. 13 is a schematic plan view illustrating Modified Example 3 of the liquid crystal display device of Embodiment 1.

### Embodiment 2

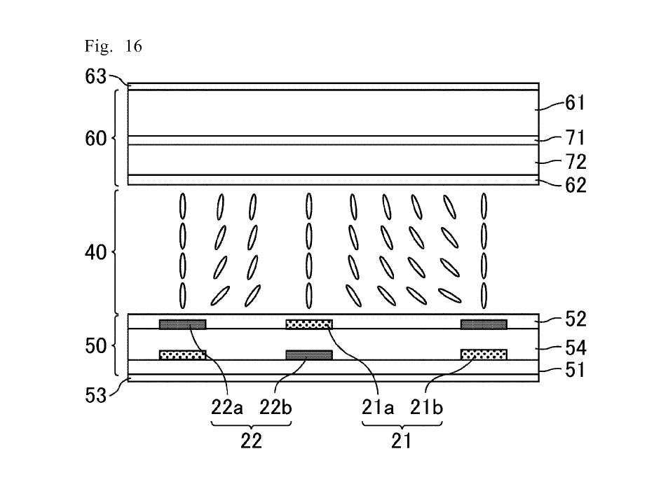

FIG. 16 is a schematic cross-sectional view illustrating a configuration of a liquid crystal display device of Embodiment 2. As illustrated in FIG. 16, a liquid crystal display device of Embodiment 2 comprises a liquid crystal display panel having a pair of substrates 50 and 60 and a liquid crystal layer 40 interposed between the substrates 50 and 60. One of the pair of substrates is a TFT substrate 50 and the other is a counter substrate 60.

The liquid crystal display device of Embodiment 2 is different from the liquid crystal display device of Embodiment 1 in the following point. The liquid crystal display device of the present embodiment has a counter electrode 71 on the counter substrate 60 side. As illustrated in FIG. 16, the counter substrate 60 includes a transparent substrate 61. On the main surface of the transparent substrate 61 on the liquid crystal layer 40 side, a counter electrode 71, a dielectric layer (insulating layer) 72, and a vertical alignment film 44 are stacked in this order. Here, between the counter electrode 71 and the transparent substrate 41, a black matrix and/or a color filter may be formed.

The counter electrode 71 is formed of a transparent conductive film such as an ITO film and an IZO film. The counter electrode 71 and the dielectric layer 72 are continuously formed to cover at least the whole display region. A predetermined electric potential that is a common potential for all the picture elements is applied to the counter electrode 71.

The dielectric layer 72 is formed of transparent insulating materials. More specifically, the dielectric layer 72 is formed of an inorganic insulating film such as a silicon nitride film, an organic insulating film such as acrylic resins, or the like.

The TFT substrate 50 comprises a transparent substrate 51. In the TFT substrate 50, a pixel electrode 21, a common electrode 22, an insulating film 54, and a vertical alignment film 34 are provided in the same manner as in Embodiments 1. Moreover, on the outer main surfaces of the TFT substrate 50 and the counter substrate 60, a first polarizer 53 and a second polarizer 63 are provided.

Here, the applied voltage is different between the pixel electrode 21 and the common electrode 22 and also between the pixel electrode 21 and the counter electrode 71, except when black display is conducted. The common electrode 22 and the counter electrode 71 may be grounded. Moreover, the magnitude and the polarity of the applied voltage may be different or not different between the common electrode 22 and the counter electrode 71.

The liquid crystal display device of the present embodiment also increases the aperture ratio in the same manner as in Embodiment 1. Moreover, formation of the counter electrode 71 enhances the response speed.

The present application claims priority to Patent Application No. 2009-193030 filed in Japan on Aug. 24, 2009 and Patent Application No. 2010-005109 filed in Japan on Jan. 13, 2010 under the Paris Convention and provisions of national law in a designated State, the entire contents of which are hereby incorporated by reference.

### EXPLANATION OF NUMERALS AND SYMBOLS

4: Liquid crystal molecules
11: Source wiring
12: Gate wiring
13: Cs wiring
17: TFT (Thin Film Transistor)
21: Pixel electrode
21a: Comb-tooth portion of pixel electrode
21b: Extension of pixel electrode
22: Common electrode
22a: Comb-tooth portion of Common electrode
22b: Extension of Common electrode
31: Source substrate
32: Gate electrode
33: Drain electrode
34: Semiconductor layer
35: Cs electrode
40: Liquid crystal layer
41: First contact portion
42: Second contact portion
50: TFT substrate
51: Transparent substrate (On TFT-substrate side)
52: Vertical alignment film (On TFT-substrate side)
53: First polarizer (On TFT-substrate side)
54: Insulating film
60: Counter substrate
61: Transparent substrate (On counter-substrate side)
62: Vertical alignment film (On counter-substrate side)
63: Second polarizer (On counter-substrate side)
71: Counter electrode
72: Dielectric layer
104: Liquid crystal molecules
140: Liquid crystal layer
150, 160: Substrate
121: Pixel electrode
122: Common electrode
141: Contact portion
151, 161: Transparent substrate
152, 163: Vertical alignment film
153, 163: Polarizer

1. A liquid crystal display device comprising:
a pair of substrates positioned to face each other; and
a liquid crystal layer interposed between the substrates,
wherein the liquid crystal layer contains a liquid crystal molecule having positive dielectric anisotropy,
the liquid crystal molecule is aligned in a direction vertical to surfaces of the substrates when no voltage is applied,
one of the substrates comprises a first electrode and a second electrode, the electrodes respectively including comb-tooth portions that are alternately engaged at a certain interval,
the first electrode comprises an extension in a layer separated by an insulating film from a layer in which an engagement between the comb-tooth portions of the first electrode and of the second electrode is formed, and
the extension of the first electrode is positioned more distant from the liquid crystal layer than the comb-tooth portion of the second electrode is, and is positioned along the comb-tooth portion of the second electrode in an overlapping manner.

2. The liquid crystal display device according to claim 1,
wherein the extension of the first electrode has a width narrower than the width of the comb-tooth portion of the second electrode.

3. The liquid crystal display device according to claim 1,
wherein the second electrode has an extension in a layer separated by the insulating film from the layer in which the engagement with the comb-tooth portion of the first electrode is formed,
the extension of the second electrode is positioned more distant from the liquid crystal layer than the comb-tooth portion of the first electrode is, and is positioned along the comb-tooth portion of the first electrode in an overlapping manner.

4. The liquid crystal display device according to claim 3,
wherein the extension of the second electrode has a width narrower than the width of the comb-tooth portion of the first electrode.

5. The liquid crystal display device according to claim 3,
wherein the extension of the first electrode and the extension of the second electrode are alternately engaged at a certain interval.

6. The liquid crystal display device according to claim 1,
wherein the first electrode is a pixel electrode and the second electrode is a common electrode.

7. The liquid crystal display device according to claim 1,
wherein the first electrode is a common electrode and the second electrode is a pixel electrode.
